(19) United States
(12) Patent Application Publication
(10) Pub. No.: US 2020/0234181 A1
(43) Pub. Date: Jul. 23, 2020

(54) IMPLEMENTING TRAINING OF A MACHINE LEARNING MODEL FOR EMBODIED CONVERSATIONAL AGENT

(71) Applicant: International Business Machines Corporation, Armonk, NY (US)

(72) Inventors: Edward Graham Katz, Washington, DC (US); Alexander Charles Tonetti, Washington, DC (US); John A. Riendeau, Madison, WI (US); Charles E. Beller, Baltimore, MD (US)

(21) Appl. No.: 16/253,457

(22) Filed: Jan. 22, 2019

(51) Int. Cl. G06N 20/00; G06N 3/00

(52) U.S. Cl. CPC G06N 20/00; G06N 3/006

(57) ABSTRACT

A method, system and computer program product are provided for implementing enhanced training of a personality model for an embodied conversational agent. An adjustable personality model is provided for the conversational agent interacting with a user with the adjustable personality model configured to provide emotion and tone responses based on detected emotions of the user and a communication objective. Responsive to detecting a first emotion of the user in a conversation with the conversational agent, the adjustable personality model is utilized to embody the conversational agent with a first emotion and tone. Responsive to detecting a second emotion of the user different from the first emotion, the adjustable personality model is utilized to embody the conversational agent with a second emotion and tone possibly different from the first emotion and tone.

### FIELD OF THE INVENTION

The present invention relates generally to the data processing field, and more particularly, relates to a method, system and computer program product for implementing enhanced training of a personality model for an embodied conversational agent.

### DESCRIPTION OF THE RELATED ART

A need exists for automatically configuring a multi-model conversational agent to display appropriate personality in an optimal way. Natural conversational interaction involves an emotional interaction as well as an informational interaction. A conversational participant might be annoyed or angered or pleased by their interlocutor's statement resulting from the content or the form of the interaction and this emotional reaction will often find expression in the form and content of a response. A need exists to find a right way to respond to a user from within a palette of emotional responses.

The patterning of emotional reactions is often perceived as constituting something like a personality or personal style. State of the art virtual conversational agents often have a flat emotional style, in which their contributions are unmodulated by variation in emotional content of their human users. This is perceived as unnatural, particularly as the range of emotional channels for input and feedback multiplies. While for a simple textual interface only the tone of the words is relevant, for embodied systems, such as avatars, with both spoken language and visual input and output a range of ways expressing an emotional response are available, in addition, a range of ways of perceiving the human user's emotional state is available, as well. To bring emotion to the interaction, it is useful to equip an embodied agent with a personality model.

A need exists for an efficient and effective mechanism to train a personality model for an emotionally intelligent embodied conversational system.

### SUMMARY OF THE INVENTION

Principal aspects of the present invention are to provide a method, system and computer program product for implementing enhanced training of a personality model for an embodied conversational agent. Other important aspects of the present invention are to provide such method, system and computer program product substantially without negative effects and that overcome many of the disadvantages of prior art arrangements.

In brief, a method, system and computer program product are provided for implementing enhanced training of a personality model for an embodied conversational agent. An adjustable personality model is provided for the conversational agent interacting with a user with the adjustable personality model configured to provide emotion and tone responses based on detected emotions of the user and a communication objective. Responsive to detecting a first emotion of the user in a conversation with the conversational agent, the adjustable personality model is utilized to embody the conversational agent with a first emotion and tone. Responsive to detecting a second emotion of the user different from the first emotion, the adjustable personality model is utilized to embody the conversational agent with a second emotion and tone different from the first emotion and possibly tone.

In accordance with features of the invention, the personality model captures a pattern of emotional responses that characterize the personality of the cognitive agent, for example, the propensity to respond to anger with fear. A personality model is crucial to embodied conversational agents, because their emotional responses need to be consistently modulated across multiple modalities, such as timber of voice, facial expression, and the like. Adjustable personality models enable more natural interaction as well as emotionally artificial intelligent interaction.

In accordance with features of the invention, the adjustable personality model is based on identified user intents and a current ability to assist with the user intents.

In accordance with features of the invention, an emotion portrayed by the embodied conversational agent is selected from a group including agreeable, frustrated, apologetic, happy, sad, sympathetic, and angry.

In accordance with features of the invention, the detected emotions of the user are determined by an emotion detection system.

In accordance with features of the invention, the emotion detection system analyzes input selected from a group including audio, facial, text, keyboard pressure, and sensors.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 provides a block diagram of an example computer system for implementing enhanced training of a personality model for an embodied conversational agent in accordance with preferred embodiments;

FIGS. 2, and 3 are respective flow chart illustrating example system operations to implement enhanced training of a personality model for an embodied conversational agent in accordance with preferred embodiments; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized, and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method, system and computer program product are provided for implementing enhanced training of a personality model for an embodied conversational agent. An adjustable personality model is provided for the conversational agent interacting with a user with the adjustable personality model configured to provide emotion and tone responses based on detected emotions of the user and a communication objective. Responsive to detecting a first emotion of the user in a conversation with the conversational agent, the adjustable personality model is utilized to embody the conversational agent with a first emotion and tone. Responsive to detecting a second emotion of the user different from the first emotion, the adjustable personality model is utilized to embody the conversational agent with a second emotion and tone possibly different from the first emotion and tone.

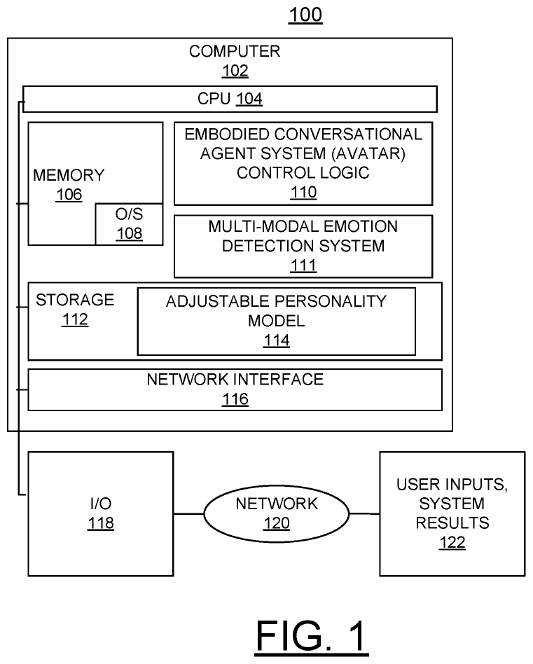

Having reference now to the drawings, in FIG. 1, there is shown an example system embodying the present invention generally designated by the reference character 100 for implementing enhanced training of a personality model for an embodied conversational agent system in accordance with preferred embodiments. System 100 includes a computer system 102 including one or more processors 104 or general-purpose programmable central processing units (CPUs) 104. As shown, computer system 102 includes a single CPU 104; however, system 102 can include multiple processors 104 typical of a relatively large system.

Computer system 102 includes a system memory 106 including an operating system 108, an embodied conversational agent system (avatar) control logic 110 and a multi-modal emotion detection system 111 in accordance with preferred embodiments. System memory 106 is a random-access semiconductor memory for storing data, including programs. System memory 106 is comprised of, for example, a dynamic random-access memory (DRAM), a synchronous direct random-access memory (SDRAM), a current double data rate (DDRx) SDRAM, non-volatile memory, optical storage, and other storage devices.

Computer system 102 includes a storage 112 including an adjustable personality model 114 in accordance with preferred embodiments and a network interface 116. Computer system 102 includes an I/O interface 118 for transferring data to and from computer system components including CPU 104, memory 106 including the operating system 108, embodied conversational agent system (avatar) control logic 110, multi-modal emotion detection system 111, storage 112 including adjustable personality model 114, and network interface 116, and a network 120 coupling user system inputs and system results 122 in accordance with preferred embodiments.

In accordance with features of the invention, the embodied conversational system (avatar) control logic 110 enables the conversational agent interacting with a user with the adjustable personality model configured to provide emotion and tone responses based upon detected emotions of the user and a communication objective.

In accordance with features of the invention, the embodied conversational agent is equipped with a trainable personality model 114. The trainable or adjustable personality model 114 describes the pattern of emotional responses characteristic of the personality, for example, respond to joy with joy; respond to anger with fear, and the like. Using the method of the invention, the embodied conversational agent learns how to generate emotional responses based on the detected occurrent emotional state of the user, the semantic intent, and a goal emotional of the user specified by a system builder. The input for the emotion detection system model 111 is, for example, audio-tone analysis, face-emotion recognition, text-based tone analysis, keyboard pressure analysis, and the like. This is mapped to a representation of the occurrent emotion of the user (E_u).

In accordance with features of the invention, the conversational system control logic 112 identifies the semantic intent of the user (I_u) and generates a content semantic intent of the system (I_s). The personality model 114 computes the emotional tone specification based on the recognized tone and the recognized semantic intent of the user and the semantic intent to be output: PM (E_u, I_u, I_s)=E_s. The personality model 114 is used to modulate the display of a semantic context by the artificial cognitive agent system control logic 110, potentially influencing, among other things, speech tone, facial expression, and textual tone of output, and the like. The modulation of the output (O_s) with a systems emotional tone specification (E_s) is orchestrated for example, by the display system (Express (O_s, E_s)).

In accordance with features of the invention, the cognitive conversational system control logic 112 and multi-modal emotion detection system 111, a method is provided for training a personality model as follows.

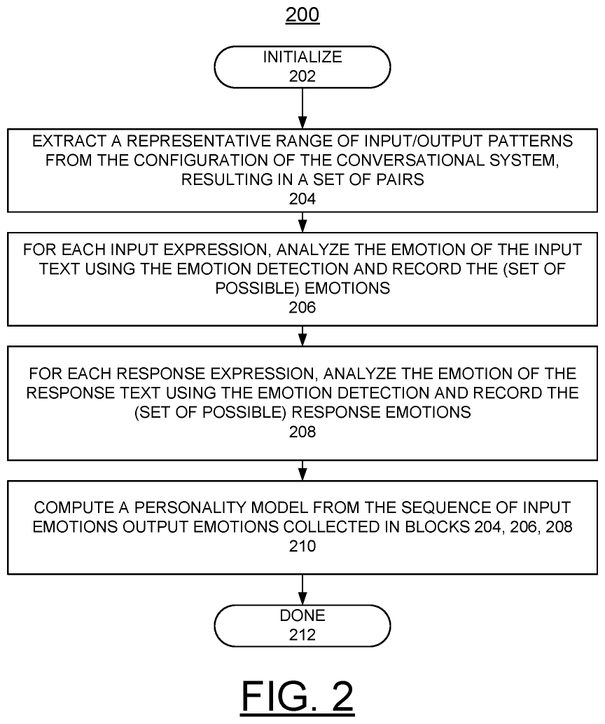

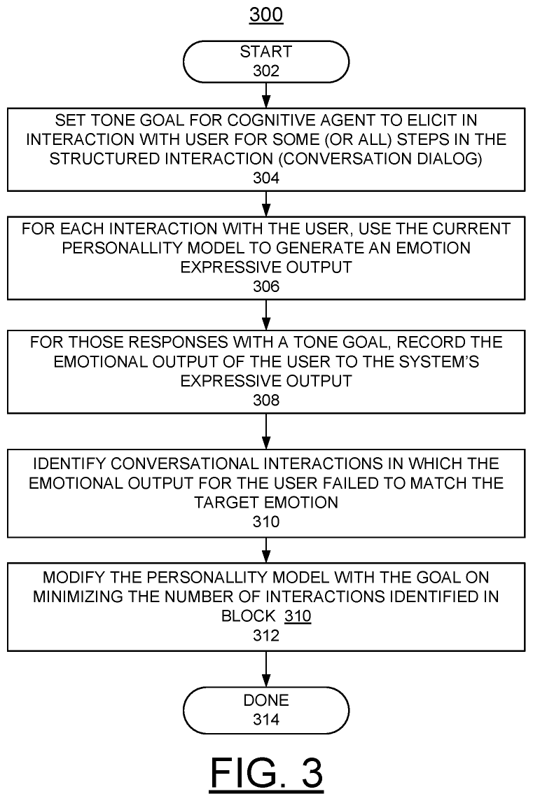

Referring to FIGS. 2 and 3, there are shown respective example system operations generally designated by the reference characters 200, and 300 of computer system 102 of FIG. 1, for implementing enhanced training of the personality model 114 for the embodied conversational agent system control logic 110 in accordance with preferred embodiments.

Referring to FIG. 2, system operations 200 to implement enhanced training of the personality model 114 start at a block 202 with initialization, for example, using tone analysis of multi-mode emotion detection system 111, identify the textual tone of the conversational system as an initialization for the personality model, by: As indicated at a block 204, extract a representative range of input/output patterns from the configuration of the conversational system, resulting in a set of pairs. As indicated at a block 206, for each input expression I, analyze the emotion of the input text using the emotion detection and record the (set of possible) response emotions.

As indicated at a block 208, For each response expression, analyze the emotion of the response text using the emotion detection and record the (set of possible) response emotions. As indicated at a decision block 210, compute a personality model from the sequence of input emotions, output emotions collected in blocks 204, 206, and 208. Operations are done as indicated at a block 212.

Referring to FIG. 3, there are shown system operations 300 to implement enhanced training of the personality model 114 start at a block 302. Set tone goal for cognitive agent to elicit in interaction with user for some (or all) steps in the structured interaction (conversational dialog) as indicated at a block 304. As indicated at a block 306, for each interaction with the user, use the current PM to generate an emotion expressive output.

As indicated at a block 308, for those responses with a tone goal, record the emotional output of the user to the system's expressive output. As indicated at a block 310, identify conversational interactions in which the emotional output of the user failed to match the target. At block 312, modify the personality model with the goal of minimizing the number of interactions identified in block 310.

In accordance with features of the invention, to initialize a personality model, the textual interactions configured in a chatbot will be used: For example:

System: “Hi, what can I do for you today?” Emotion analysis identifies: Agreeable User: “I'm so happy that I can pay my bill by talking to you!” Emotion analysis identifies: Happy
System: “I'm afraid our bill pay capability is down at the moment.” Emotion analysis identifies: Apologetic
User: “That's terrible, I'll never use this system again. Good day, sir!” Emotion analysis identifies Angry

In accordance with features of the invention, these interactions can be treated as an emotion sequence, such as the following:

(greeting) Agreeable->(bill pay) Happy->(not-possible) Apologetic->(avoid-payment) Angry-> . . . .

Standard sequence learning methods such as Hidden Markov Models can be used to construct the personality model from these sequences. Such a model might be represented as a simply input output mapping:

User Intent/System intent Recognized Emotion Emotional Response:

### Pay_bill/Facilitate Agreeable

Pay_bill/Can't facilitate Frustrated Apologetic

### Avoid_payment/Help Apologetic Sympathetic

### Avoid_payment/Help Angry

In accordance with features of the invention, the personality model is sufficient for orchestrating the emotional response of the user so that it is consistent. To further train the system, some or all of the interactions can be annotated with a desired emotional response. This may be either done for each interaction or, more reasonably, for the final interaction. To specify that the goal of the interaction is that user is happy, for example:

System: “Hi, what can I do for you today?” Emotion to display marked as: Agreeable
User: “I'm so happy that I can pay my bill by talking to you!” Emotion analysis identifies: Happy
System: “I'm glad to tell you our bill pay capability is down at the moment.” Emotion to display marked as: Agreeable
User: “That's terrible, I'll never use this insolent system again. Good day, sir!” Emotion analysis identifies: Angry Goal: Happy

In accordance with features of the invention, identifying that the interaction has failed to achieve the goal emotion state for the user, the training method is applied, and the personality model is altered. One way in which the personality model might be altered is to collect cases in which the output is producing an undesirable response, identify the most common case and introducing a variation of the model that would lead to a different response (here, for example, modifying the model so that the emotion to display in the case of a user input emotion Agreeable with user Intent (I_u) Bill_Pay_Request and system intent (I_s) System_Down is not Agreeable but rather Apologetic.

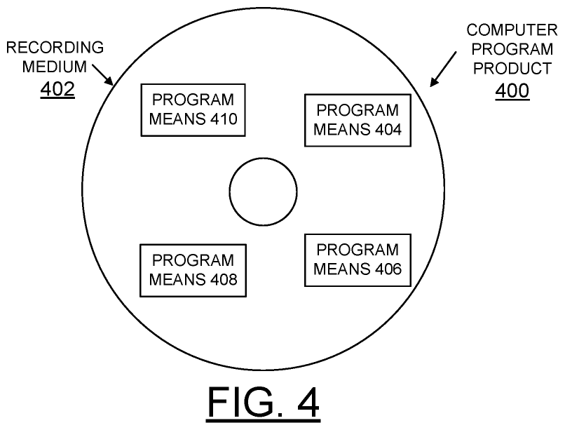

Referring now to FIG. 4, an article of manufacture or a computer program product 400 of the invention is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. The computer readable storage medium 402, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 402 stores program means or instructions 404, 406, 408, and 410 on the non-transitory computer readable storage medium 402 for carrying out the methods for implementing misleading title identification in the system 100 of FIG. 1.

Computer readable program instructions 404, 406, 408, and 410 described herein can be downloaded to respective computing/processing devices from a computer readable storage medium or to an external computer or external storage device via a network, for example, the Internet, a local area network, a wide area network and/or a wireless network. The computer program product 400 may include cloud-based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 404, 406, 408, and 410 from the network and forwards the computer readable program instructions for storage in a computer readable storage medium within the respective computing/processing device.

A sequence of program instructions or a logical assembly of one or more interrelated modules defined by the recorded program means 404, 406, 408, and 410, direct the system 100 for implementing misleading title identification of the preferred embodiment.

While the present invention has been described with reference to the details of the embodiments of the invention shown in the drawing, these details are not intended to limit the scope of the invention as claimed in the appended claims.

What is claimed is:

1. A system for implementing enhanced training of a personality model for an embodied conversational agent comprising:
an embodied conversational system control logic;
said embodied conversational system control logic and a multi-modal emotion detection system tangibly embodied in a non-transitory machine readable medium used to implement enhanced training of an adjustable personality model configured to provide emotion and tone responses based on detected emotions of a user and a communication objective;
said embodied conversational system control logic, responsive to detecting a first emotion of the user in a conversation with an embodied conversational agent, utilizing the adjustable personality model to embody the embodied conversational agent with a first emotion and tone; and
said embodied conversational system control logic, responsive to detecting a second emotion of the user different from the first emotion, utilizing the adjustable personality model to embody the embodied conversational agent with a second emotion and tone different from the first emotion and tone.

2. The system as recited in claim 1, includes said adjustable personality model based on identified user intents and a current ability to assist with the user intents.

3. The system as recited in claim 2, includes an emotion portrayed by the embodied conversational agent is selected from a group including agreeable, frustrated, apologetic, happy, sad, sympathetic, and angry.

4. The system as recited in claim 1, wherein detected emotions of the user are determined by an emotion detection system.

5. The system as recited in claim 4, wherein the emotion detection system analyzes input selected from a group including audio, facial, text, keyboard pressure, and sensors.

6. The system as recited in claim 1, wherein the personality model captures a pattern of emotional responses that characterize the personality of the conversational agent.

7. The system as recited in claim 1, wherein the personality model enables the embodied conversational agent with predefined emotional responses.

8. The system as recited in claim 7, wherein the predefined emotional responses are consistently modulated across multiple modalities.

9. The system as recited in claim 1, wherein the multiple modalities include at least one of timber of voice, and facial expression.

10. The system as recited in claim 1, wherein the personality model enables enhanced natural interaction of the embodied conversational agent and the user.

11. The system as recited in claim 1, wherein the personality model enables enhanced emotionally artificial intelligent interaction of the embodied conversational agent and the user.

12. A method for implementing enhanced training of a personality model for an embodied conversational agent comprising:
providing an embodied conversational system control logic;
said embodied conversational system control logic and a multi-modal emotion detection system tangibly embodied in a non-transitory machine readable medium used to implement enhanced training of an adjustable personality model configured to provide emotion and tone responses based on detected emotions of a user and a communication objective comprising:
responsive to detecting a first emotion of the user in a conversation with an embodied conversational agent, utilizing the adjustable personality model to embody the embodied conversational agent with a first emotion and tone; and
responsive to detecting a second emotion of the user different from the first emotion, utilizing the adjustable personality model to embody the embodied conversational agent with a second emotion and tone different from the first emotion and tone.

13. The method as recited in claim 12, includes providing said adjustable personality model based upon identified user intents and a current ability to assist with the user intents.

14. The method as recited in claim 12, includes selecting an emotion portrayed by the embodied conversational agent from a group including agreeable, frustrated, apologetic, happy, sad, sympathetic, and angry.

15. The method as recited in claim 12, includes determining detected emotions of the user by an emotion detection system.

16. The method as recited in claim 15, includes analyzing input selected from a group including audio, facial, text, keyboard pressure, and sensors with the emotion detection system.

17. The method as recited in claim 12, includes capturing a pattern of emotional responses with the personality model that characterize the personality of the conversational agent.

18. The method as recited in claim 12, includes enabling the embodied conversational agent with predefined emotional responses with the personality model.

19. The method as recited in claim 12, includes consistently modulating the predefined emotional responses across multiple modalities including at least one of timber of voice, and facial expression.

20. The method as recited in claim 12, includes enabling enhanced natural interaction of the embodied conversational agent and the user with the personality model.
